(19) United States
(12) Patent Application Publication
(10) Pub. No.: US 2023/0093488 A1
(43) Pub. Date: Mar. 23, 2023

(54) TRACTOR MOUNTABLE AUXILIARY TANK SYSTEM

(71) Applicant: Luke Nicholas Trio, Easton, MN (US)

(72) Inventor: Luke Nicholas Trio, Easton, MN (US)

(21) Appl. No.: 17/479,663

(22) Filed: Sep. 20, 2021

(51) Int. Cl. A01M 7/00; B60P 3/22

(52) U.S. Cl. CPC A01M 7/0085; B60P 3/22

(57) ABSTRACT

A tractor mountable auxiliary tank system includes a frame that is secured to a body of the tractor such that an axle of the tractor extends below a top side of the frame. A tank for holding a quantity of liquid has a top wall, a bottom wall, and a perimeter wall extending between the top and bottom walls. The perimeter wall includes a front wall, a rear wall, a first lateral wall and a second lateral wall. The bottom wall has a shape conforming to a top side of the frame such that the tank is stabilized by the frame. The tank is positioned between the body and a ground engagement member engaged with the axle. A coupling member releasably couples the tank to the frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tractor mounted tank apparatus and more particularly pertains to a new tractor mounted tank apparatus for allowing the retrofitting of additional fluid carrying tanks to a tractor such that the overall volume of the fluid, such as liquid fertilizers, is available to the operator of the tractor.

### (2) Description of Related Art Including Information Disclosed Under 37 CFR 1.97 and 1.98

The prior art relates to tractor mounted tank apparatuses which are attached to the body of the tractor but which do not utilize an open space between a body of the tractor and the wheels or tracks attached to the tractor.

### BRIEF SUMMARY OF THE INVENTION

An embodiment of the disclosure meets the needs presented above by generally comprising a frame that is configured to be securable to a body of the tractor such that an axle of the tractor extends below a top side of the frame. A tank configured for holding a quantity of liquid has a top wall, a bottom wall, and a perimeter wall extending between the top and bottom walls. The perimeter wall includes a front wall, a rear wall, a first lateral wall and a second lateral wall. The bottom wall has a shape conforming to a top side of the frame such that the tank is stabilized by the frame. The tank is positioned between the body and a ground engagement member engaged with the axle. A coupling member releasably couples the tank to the frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear and top isometric view of a tractor mountable auxiliary tank system according to an embodiment of the disclosure.

FIG. 2 is a front and top isometric view of an embodiment of the disclosure.

FIG. 3 is a right side view of an embodiment of the disclosure.

FIG. 4 is a front view of an embodiment of the disclosure.

FIG. 5 is a left side view of an embodiment of the disclosure.

FIG. 6 is a right view of an embodiment of the disclosure.

FIG. 7 is a rear isometric view of an embodiment of the disclosure.

FIG. 8 is a front in-use view of an embodiment of the disclosure.

FIG. 9 is a front isometric view of an embodiment of the disclosure.

FIG. 10 is a front isometric view of an embodiment of the disclosure.

FIG. 11 is a front isometric view of an embodiment of the disclosure.

FIG. 12 is a front isometric in-use view of an embodiment of the disclosure.

### DETAILED DESCRIPTION OF THE INVENTION

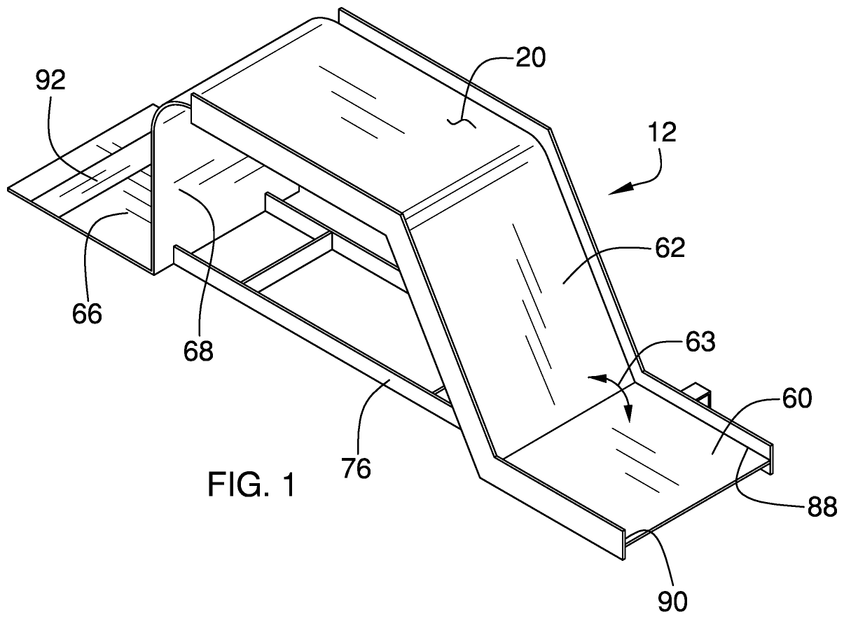

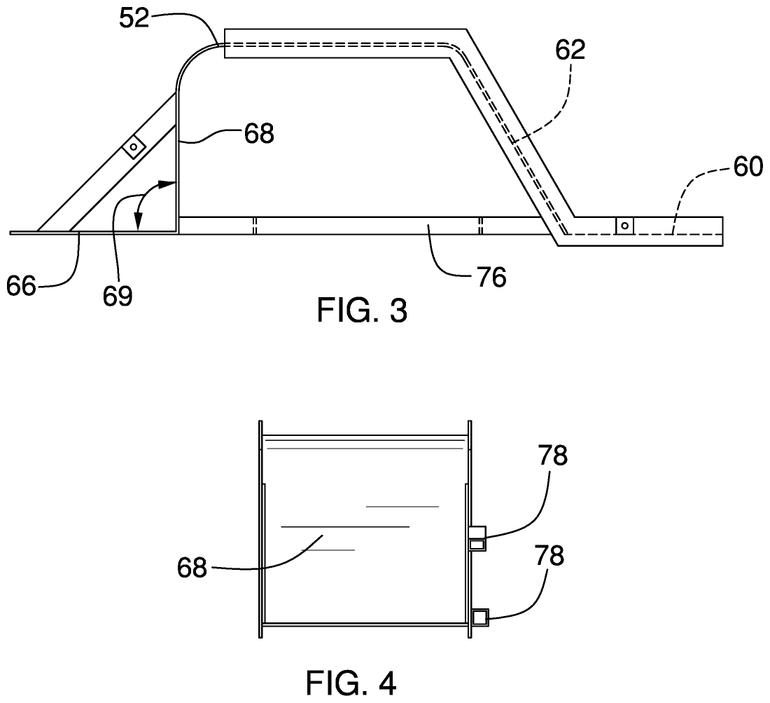

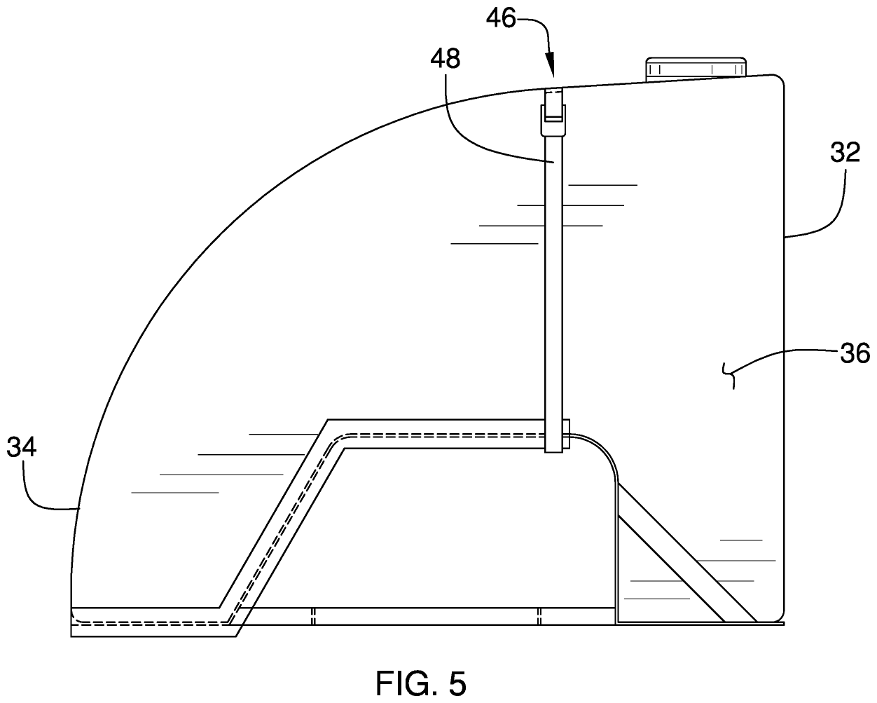

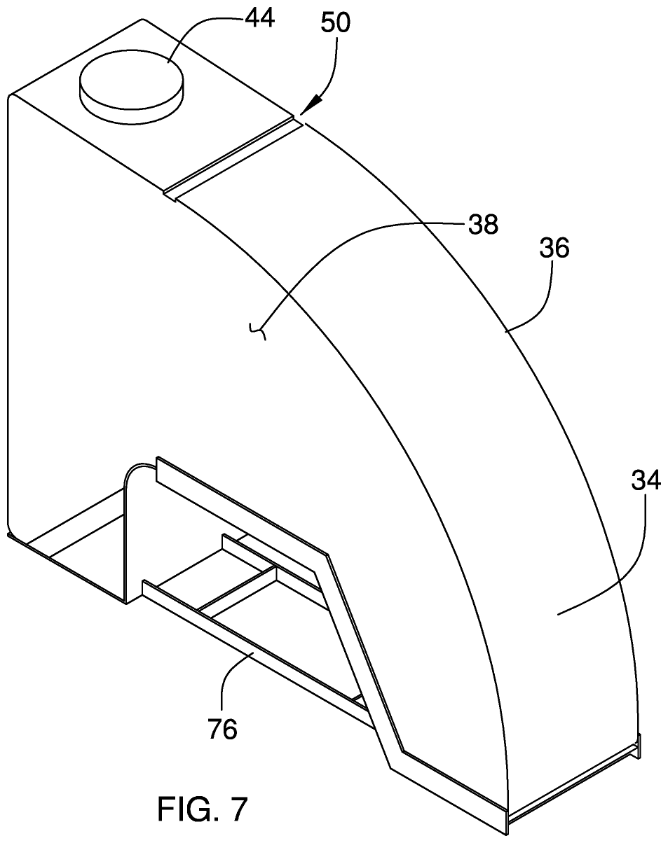

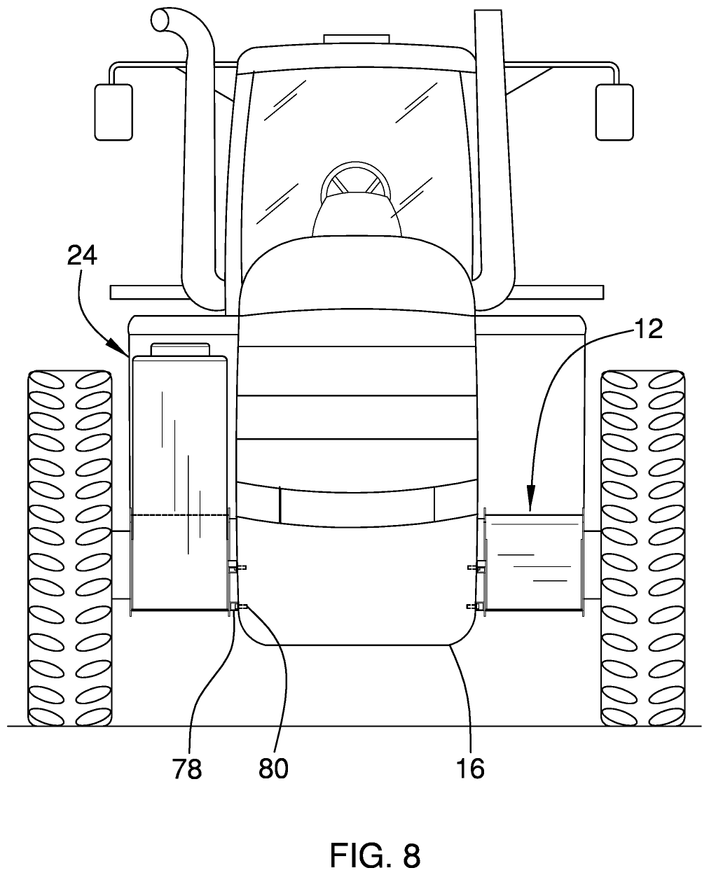

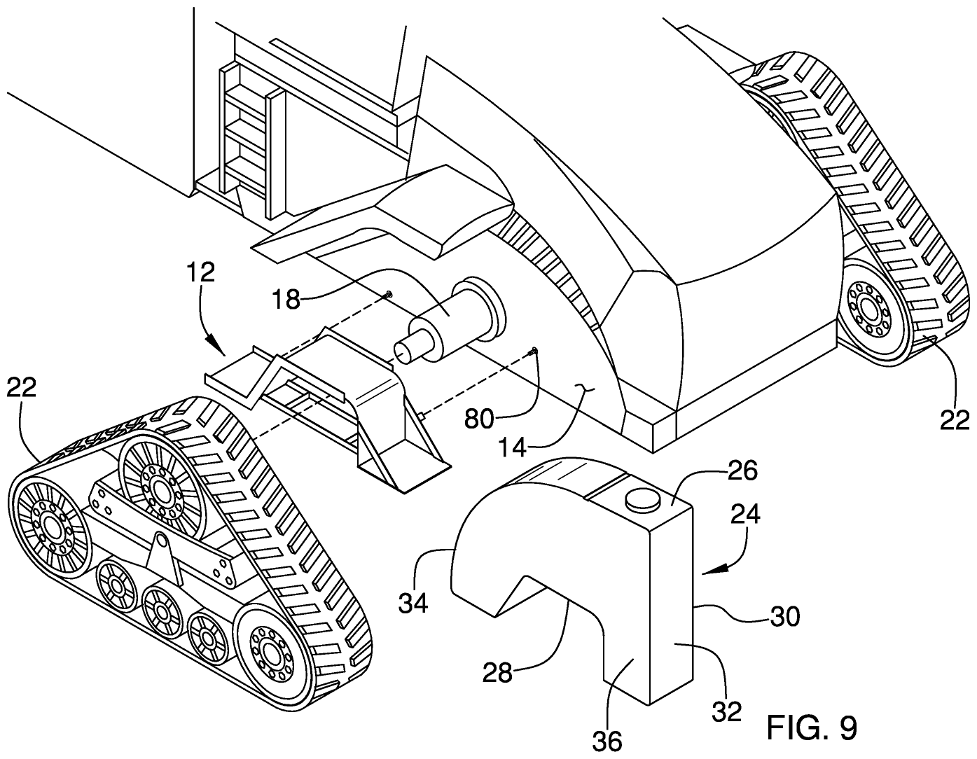

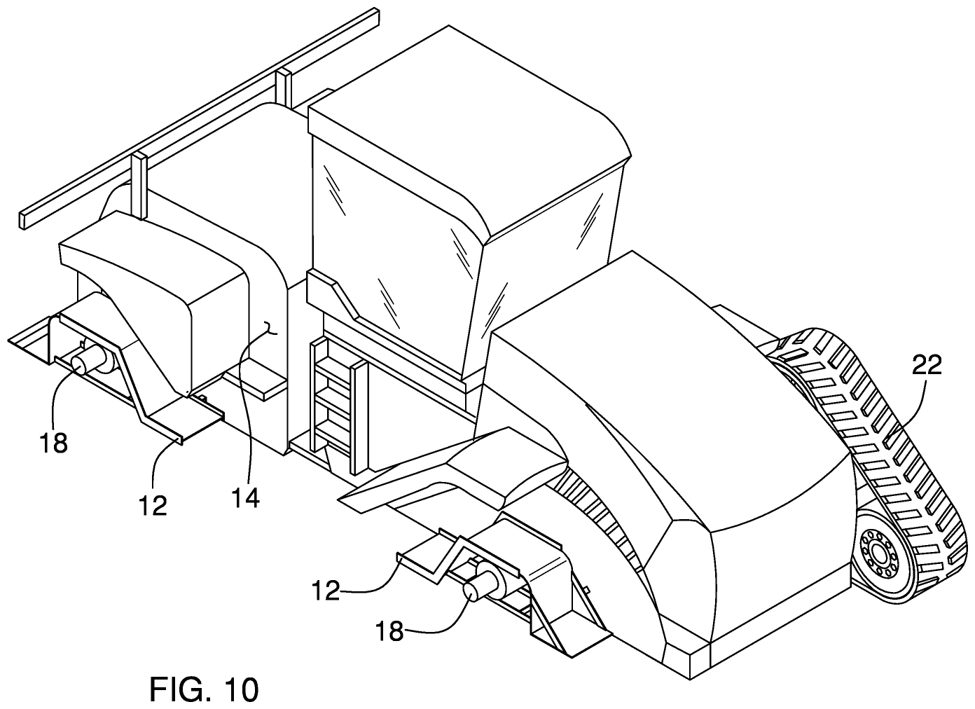

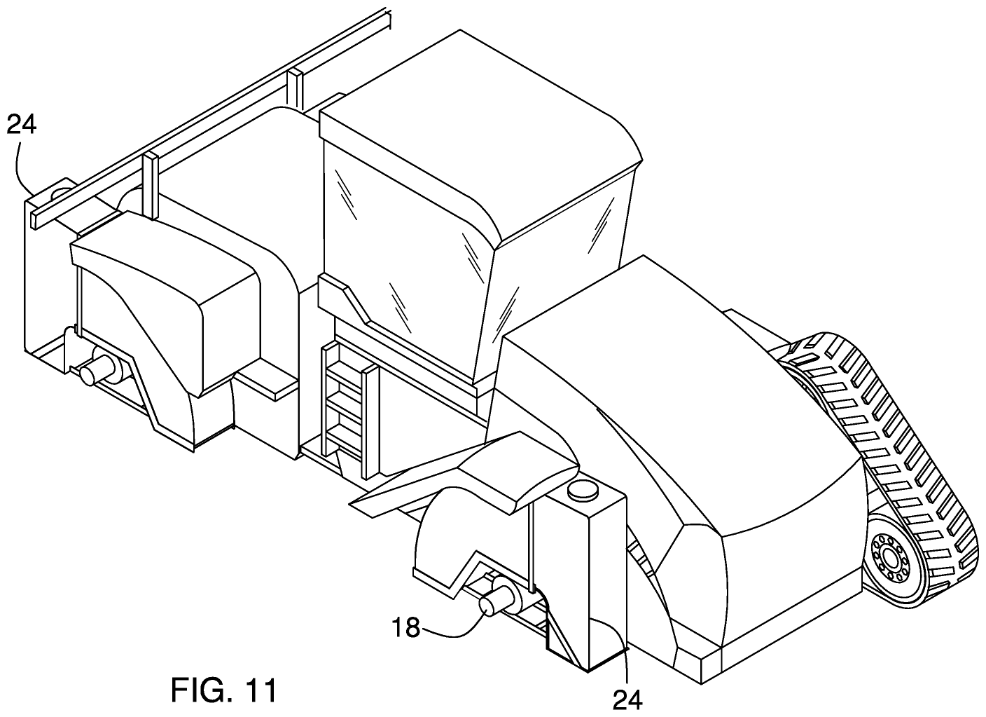

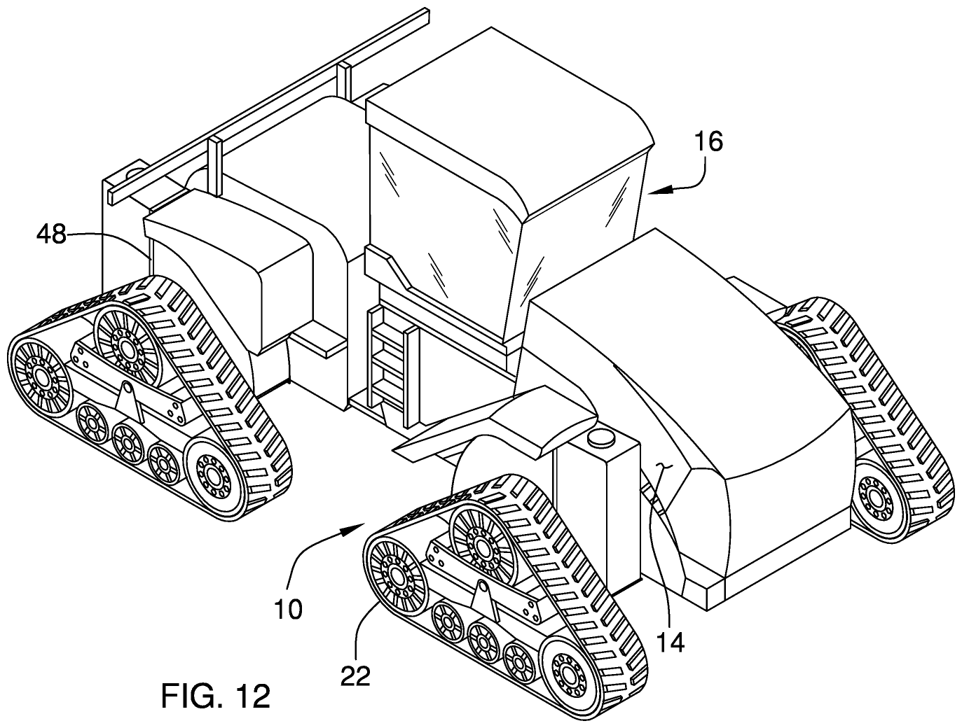

With reference now to the drawings, and in particular to FIGS. 1 through 12 thereof, a new tractor mounted tank apparatus embodying the principles and concepts of an embodiment of the disclosure and generally designated by the reference numeral 10 will be described.

As best illustrated in FIGS. 1 through 12, the tractor mountable auxiliary tank system 10 generally comprises a frame 12 that is configured to be securable to a body 14 of a tractor 16 such that an axle 18 of the tractor 16 extends below a top side 20 of the frame 12. The axle 18 is conventional and is mechanically coupled to a drivetrain of the tractor 16. The axle 18 engages a ground engagement member 22 which may include a track, as shown in the Figures, or one or more wheels.

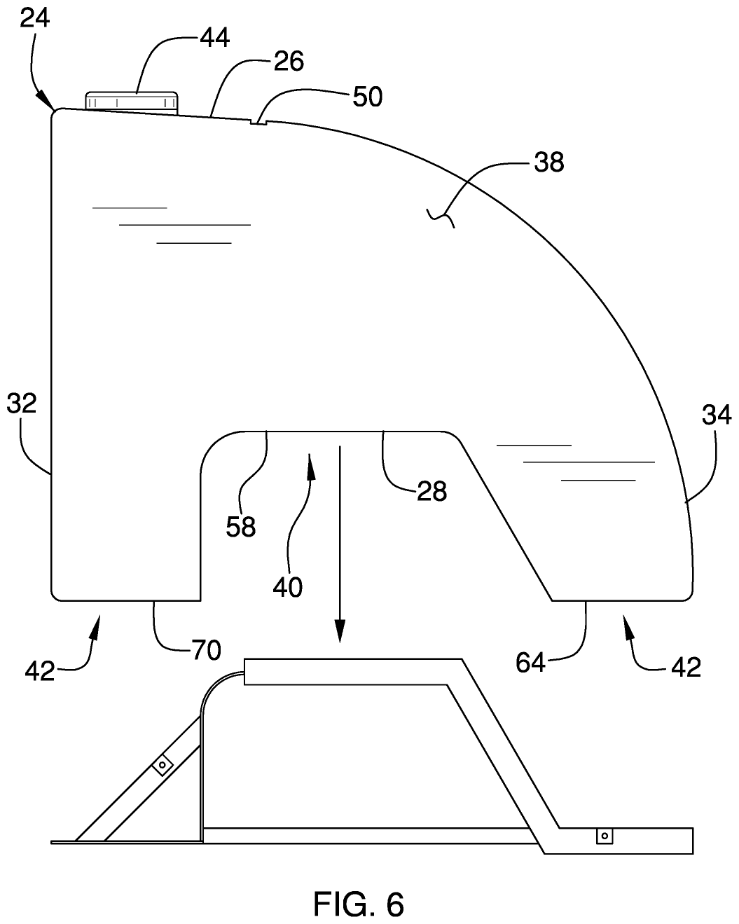

A tank 24 configured for holding a quantity of liquid is provided. The liquid may comprise, for example, liquid fertilizer or herbicides to be applied to crops. The tank 24 may include conventional hoses, not shown, fluidly coupled to a conventional dispensing system mounted on the tractor 16. The tank 24 has a top wall 26, a bottom wall 28, and a perimeter wall 30 extending between the top 26 and bottom 28 walls. The perimeter wall 30 includes a front wall 32, a rear wall 34, a first lateral wall 36 and a second lateral wall 38. It is understood that directional terms such as “front” and “rear” as used herein are utilized for convenience for understanding the description of the system 10 as the tank 24 and frame 12 on which it is mounted may be re-oriented such that the front wall 32 faces in a direction forward of the tractor 16 or rearward of the tractor 16. The bottom wall 28 has a shape conforming to the top side 20 of the frame 12 such that the tank 24 is stabilized by the frame 12. That is, the bottom wall 28 is supported generally along its length by the top side 20 of the frame and may include a bottom perimeter edge of the tank 24 not extending laterally, forwardly, or rearwardly beyond the frame 12. In some embodiments as shown in FIG. 6, the tank 24 includes a central portion 40 and a pair of spaced, downwardly extending portions 42 to somewhat resemble an inverted “U” shape. The tank 24 is positioned between the body 14 and the ground engagement member 22 engaged with the axle 18. The tank 24 may be comprised of conventional materials used for such tanks and including metals and plastics. A fill opening and cap 44 therefore may be positioned on the tank and most typically be positioned in the top wall 26.

In one embodiment, a coupling member 46 releasably couples the tank 24 to the frame 12 and includes a strap 48 extending around the tank 24 and the frame 12. The strap 48 may be embedded into a slot 50 extending across the top wall 26 to retain the strap 48 in place relative to the tank 24. Other couplers may be utilized such as brackets, fasteners, adhesives, and the like securing the tank 24 to the frame 12.

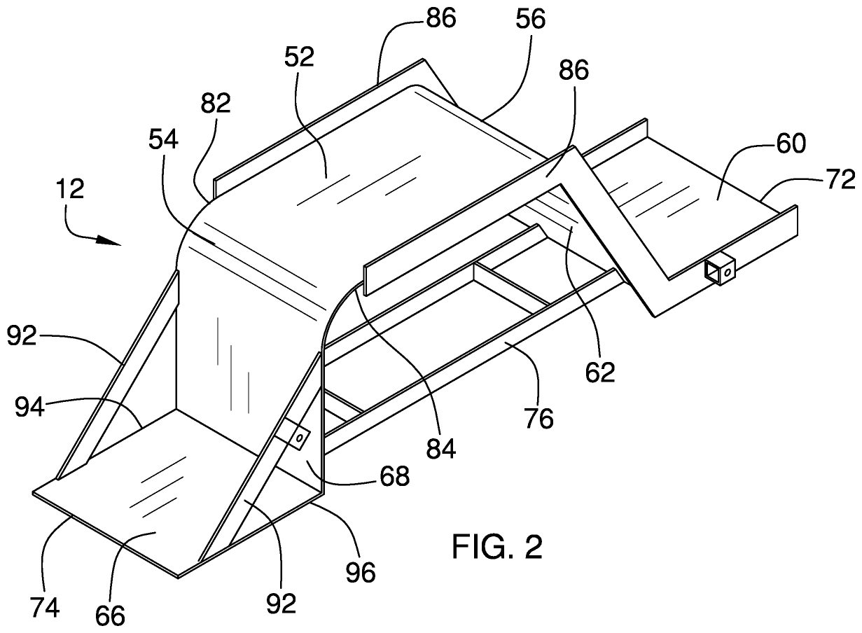

The Figures, and with particular attention directed to FIG. 2, depict an embodiment of the frame 12 that includes an upper section 52 which is horizontally orientated. The upper section 52 has a forward end 54 and a rearward end 56, wherein the upper section 52 is abutted against a medial portion 58 of the bottom wall 28. A rear section 60 is spaced rearwardly and downwardly from the upper section 52 and a rear vertical support 62 extends between the upper section 52 and the rear section 60. The rear section 60 is abutted against a rear portion 64 of the bottom wall 28. The rear vertical support 62 may form an angle 63 with the rear section 60 that is from 100° to 140°. A front section 66 is spaced forwardly and downwardly from the upper section 52. A front vertical support 68 extends between the upper section 52 and the front section 66 wherein the front section 66 is abutted against a front portion 70 of the bottom wall 28. The front vertical support 66 may form an angle 69 with the front section 66 that is from 90° to 100°.

This embodiment includes the rear section 60 having a rear edge 72, the front section 66 having a front edge 74, and a continuous panel extending from the front edge 74 to the rear edge 72. The panel may be comprised of plastics or metallic materials. However, it should be understood that the frame sections, as described above, may not be of a single piece of material but instead formed of multiple panels or a latticework of rods, plates or bars secured together to form a seat for the tank 24.

A brace 76 is attached to and extends between the rear vertical support 62 and the front vertical support 68 to provide structural rigidity to the frame 12. An axle receiving space is defined between the brace 76 and the upper section 52 such that the axle 18 is extendable between the brace 76 and the upper section 52.

A plurality of mounting brackets 78 is attached to the frame 12. The mounting brackets 78 include opening for receiving fasteners 80. Each of the fasteners 80 extends through one of the mounting brackets 78 and into the body to rigidly secure the frame 12 to the body 14. However, it should be understood that other types of securing methods, including welding, may be used to secure the frame 12 to the tractor 16.

The upper section 52 has a first lateral edge 82 and a second lateral edge 84. A pair of flanges 86 may be provided wherein each of the first 82 and second 84 lateral edges has one of the flanges 86 attached thereto and extending upwardly therefrom such that the tank 24 is positioned between the flanges 86. The flanges 86 facilitate the placement of the tank 24 properly on the frame 12 and prevent the tank 24 from moving laterally with respect to the frame 12. The rear section 60 and the rear vertical support 62 each have a first lateral edge 88 and a second lateral edge 90 being continuous with corresponding ones of the first 82 and second lateral edges 84 of the upper section 52. The flanges 86 may extend along the first 88 and second lateral 90 edges of rear section 60 and the rear vertical support 62. Rails 92 may be attached to the frame and extend between first lateral edges 94 of the front section 66 and front vertical support 68 and between second lateral edges 96 of the front section 66 and the front vertical support 68. The rails 92 additionally laterally stabilize the tank 24 relative to the frame 12.

In use, the frame 12 is attached to the tractor 16 as indicated above and as shown in the Figures to form locations for placing the tanks 24. This allows an otherwise un-used area adjacent to the body to hold additional quantities of liquid fertilizer or other liquids. Multiples ones of the tanks 24 and frames 12 may be used such that four pairs of frames 12 and tanks 24 are mounted to the tractor 12 to vastly increase the amount of fluid that is available for dispersing onto soil and crops. The tanks 24 are connected to a conventional dispersant system using conventional fluid conduits.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An auxiliary fertilizer tank system configured for mounting on a tractor, the system including:
a frame being configured to be securable to a body of the tractor such that an axle of the tractor extends below a top side of the frame;
a tank configured for holding a quantity of liquid, the tank having a top wall, a bottom wall, and a perimeter wall extending between the top and bottom walls, the perimeter wall including a front wall, a rear wall, a first lateral wall and a second lateral wall, the bottom wall having a shape conforming to a top side of the frame such that the tank is stabilized by the frame, the tank being positioned between the body and a ground engagement member engaged with the axle; and
a coupling member releasably coupling the tank to the frame.

2. The auxiliary fertilizer tank system according to claim 1, wherein the frame includes an upper section being horizontally orientated, the upper section having a forward end and a rearward end, the upper section being abutted against a medial portion of the bottom wall.

3. The auxiliary fertilizer tank system according to claim 2, wherein the frame further includes:
a rear section being spaced rearwardly and downwardly from the upper section, a rear vertical support extending between the upper section and the rear section, the rear section being abutted against a rear portion of the bottom wall; and
a front section being spaced forwardly and downwardly from the upper section, a front vertical support extending between the upper section and the front section, the front section being abutted against a front portion of the bottom wall.

4. The auxiliary fertilizer tank system according to claim 3, wherein the rear vertical support forming an angle with the rear section being from 100° to 140°, the front vertical support forming an angle with the front section being from 90° to 100°.

5. The auxiliary fertilizer tank system according to claim 3, wherein the rear section has a rear edge and the front section has a front edge, the frame including a continuous panel extending from the front edge to the rear edge.

6. The auxiliary fertilizer tank system according to claim 3, further including a brace being attached to and extending between the rear vertical support and the front vertical support, wherein an axle receiving space is defined between the brace and the upper section such that the axle is extendable between the brace and the upper section.

7. The auxiliary fertilizer tank system according to claim 1, further including a plurality of mounting brackets being attached to the frame, a plurality of fasteners, each of the fasteners extending through one of the brackets and into the body.

8. The auxiliary fertilizer tank system according to claim 2, wherein the upper section has a first lateral edge and a second lateral edge, the frame further including a pair of flanges, each of the first and second lateral edges having one of the flanges attached thereto and extending upwardly therefrom such that the tank is positioned between the flanges.

9. The auxiliary fertilizer tank system according to claim 4, wherein the upper section has a first lateral edge and a second lateral edge, the frame further including a pair of flanges, each of the first and second lateral edges having one of the flanges attached thereto and extending upwardly therefrom such that the tank is positioned between the flanges.

10. The auxiliary fertilizer tank system according to claim 9, wherein the rear section and the rear vertical support each have a first lateral edge and a second lateral edge being continuous with corresponding ones of the first and second lateral edges of the upper section, each of the flanges extending along the first and second lateral edges of rear section and the rear vertical support.

11. The auxiliary fertilizer tank system according to claim 10, further including a brace being attached to and extending between the rear vertical support and the front vertical support, wherein an axle receiving space is defined between the brace and the upper section such that the axle is extendable between the brace and the upper section.
